(19) United States
(12) Patent Application Publication
(10) Pub. No.: US 2005/0028194 A1
(43) Pub. Date: Feb. 3, 2005

(54) Personalized news retrieval system

(76) Inventors: Jan Hermanus Elenbaas, New York, NY (US); Nevenka Dimitrova, Yorktown Heights, NY (US); Thomas McGee, Garrison, NY (US); Mark Simpson, White Plains, NY (US); Jacquelyn Annette Martino, Irvington, NY (US); Mohamed Abdel-Mottaleb, Ossining, NY (US); Marjorie Garrett, Ossining, NY (US); Carolyn Ramsey, Ossining, NY (US); Hsiang-Lung Wu, Saratoga, CA (US); Ranjit Desai, Cambridge, MA (US)

Correspondence Address: PHILIPS INTELLECTUAL PROPERTY & STANDARDS, P.O. BOX 3001, BRIARCLIFF MANOR, NY, 10510, US

(21) Appl. No.: 10/932,460

(22) Filed: Sep. 2, 2004

Related U.S. Application Data
(62) Division of application No. 09/220,277, filed on Dec. 23, 1998.
Application No. 09/220,277 is a continuation-in-part of application No. 09/006,657, filed on Jan. 13, 1998, now Pat. No. 6,363,380.

(51) Int. Cl. H04N 7/173; H04N 7/10; H04N 7/025; G06F 17/30; G06F 7/00; H04N 5/445

(52) U.S. Cl. 725/32; 725/132; 715/723; 715/704; 348/563

(57) ABSTRACT

A video retrieval system is presented that allows a user to quickly and easily select and receive stories of interest from a video stream. The video retrieval system classifies stories and delivers samples of selected stories that match each user's current preference. The user's preferences may include particular broadcast networks, persons, story topics, keywords, and the like. Key frames of each selected story are sequentially displayed; when the user views a frame of interest, the user selects the story that is associated with the key frame for more detailed viewing. This invention is particularly well suited for targeted news retrieval. In a preferred embodiment, news stories are stored, and the selection of a news story for detailed viewing based on the associated key frames effects a playback of the selected news story. The principles of this invention also allows a user to effect a directed search of other types of broadcasts as well. For example, the user may initiate an automated scan that presents samples of broadcasts that conform to the user's current preferences, akin to directed channel-surfing.

### BACKGROUND OF THE INVENTION

1. Field of the Invention

This invention relates to the field of communications and information processing, and in particular to the field of video categorization and retrieval.

2. Description of Related Art

Consumers are being provided an ever increasing supply of information and entertainment options. Hundreds of television channels are available to consumers, via broadcast, cable, and satellite communications systems. Because of the increasing supply of information, it is becoming increasingly more difficult for a consumer to efficiently select information sources that provide information of particular or specific interest. Consider, for example, a consumer who randomly searches among dozens of television channels (“channel surfs”) for topics of interest to that consumer. If a topic of specific interest to the consumer is not a popular topic, only one or two broadcasters are likely to broadcast a story dealing with this topic, and only for a short duration. Unless the consumer is advised beforehand, it is unlikely that the consumer having the interest will be tuned to the particular broadcasters' channel when the story of interest is broadcast. Conversely, if the topic of interest is very popular, many broadcasters will broadcast stories dealing with the topic, and the channel-surfing consumer will be inundated with redundant information.

Automated scanning is commonly available for radio broadcasts, and somewhat less commonly available for television broadcasts. Traditionally, these scans provide a short duration sample of each broadcast channel. If the user selects the channel, the tuner remains tuned to that channel; otherwise, the scanner steps to the next found channel. This scanning, however, is neither directed nor selective. No assistance is provided, for example, for the user to scan specifically for a news station on a radio, or a sports show on a television. Each found channel will be sampled and presented to the user, independent of the user's current interests.

The continuing integration of computers and television provides for an opportunity for consumers to be provided information of particular interest. For example, many web sites offer news summaries with links to audio-visual and multimedia segments corresponding to current news stories. The sorting and presentation of these news summaries can be customized for each consumer. For example, one consumer may want to see the weather first, followed by world news, then local news, whereas another consumer may only want to see sports stories and investment reports. The advantage of this system is the customization of the news that is being presented to the user; the disadvantage is the need for someone to prepare the summary, and the subsequent need for the consumer to read the summary to determine whether the story is worth viewing.

Advances are being made continually in the field of automated story segmentation and identification, as evidenced by the BNE (Broadcast News Editor) and BNN (Broadcast News Navigator) of the MITRE Corporation (Andrew Merlino, Daryl Morey, and Mark Maybury, MITRE Corporation, Bedford Mass., Broadcast News Navigation using Story Segmentation, ACM Multimedia Conference Proceedings, 1997, pp. 381-389). Using the BNE, newscasts are automatically partitioned into individual story segments, and the first line of the closed-caption text associated with the segment is used as a summary of each story. Key words from the closed-caption text or audio are determined for each story segment. The BNN allows the consumer to enter search words, with which the BNN sorts the story segments by the number of keywords in each story segment that match the search words. Based upon the frequency of occurrences of matching keywords, the user selects stories of interest. Similar search and retrieval techniques are becoming common in the art. For example, conventional text searching techniques can be applied to a computer based television guide, so that a person may search for a particular show title, a particular performer, shows of a particular type, and the like.

A disadvantage of the traditional search and retrieval techniques is the need for an explicit search task, and the corresponding selection among alternatives based upon the explicit search. Often, however, a user does not have an explicit search topic in mind. In a typical channel-surfing scenario, a user does not have an explicit search topic. A channel-surfing user randomly samples a variety of channels for any of a number of topics that may be of interest, rather than specifically searching for a particular topic. That is, for example, a user may initiate a random sampling with no particular topic in mind, and select one of the many channels sampled based upon the topic that was being presented on that channel at the time of sampling. In another scenario, a user may be monitoring the television in a “background” mode, while performing another task, such as reading or cooking. When a topic of interest appears, the user redirects his focus of interest to the television, then returns his attention to the other task when a less interesting topic is presented.

### BRIEF SUMMARY OF THE INVENTION

It is an object of this invention to provide a news retrieval system that allows a user to quickly and easily select and receive stories of interest. It is a further object of this invention to identify broadcasts of potential interest to a user, and to provide a random or systematic sampling of these broadcasts to the user for subsequent selection.

These objects and others are achieved by providing a system that characterizes news stories and delivers samples of selected news stories that match each user's current preference. The user's preferences may include particular broadcast networks, anchor persons, story topics, keywords, and the like. Key frames of each selected news story are sequentially displayed; when the user views a frame of interest, the user can select the news story that is associated with the key frame for detailed viewing. In a preferred embodiment, the news stories are stored, and the selection of a news story for detailed viewing effects a playback of the selected story.

Although this invention is particularly well suited for targeted news retrieval, the principles of this invention also allows a user to effect a directed search of other types of broadcasts as well. For example, the user may initiate an automated scan that presents samples of broadcasts that conform to the user's current preferences, akin to directed channel-surfing.

### BRIEF DESCRIPTION OF THE DRAWINGS

FIG. 1 illustrates an example block diagram of a personalized video search system in accordance with this invention.

FIG. 2A illustrates an example video stream 200 of a news broadcast.

FIG. 2B illustrates the extraction of key frames from a story segment of a video stream in accordance with this invention.

FIG. 3 illustrates an example user interface for a video retrieval system in accordance with this invention.

FIG. 4 illustrates an example block diagram of a consumer product 400 in accordance with this invention.

### DETAILED DESCRIPTION OF THE INVENTION

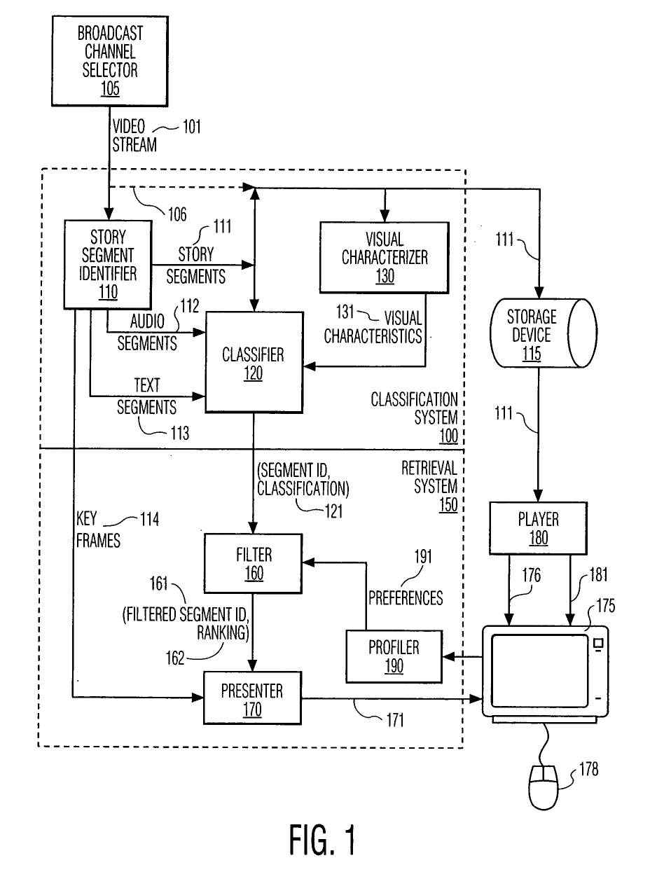

FIG. 1 illustrates an example block diagram of a personalized video search system in accordance with this invention. The video retrieval system consists of a classification system 100 that classifies each segment of a video stream and a retrieval system 150 that selects and displays segments that match one or more user preferences. The video retrieval system receives a video stream 101 from a broadcast channel selector 105, for example a television tuner or satellite receiver. The video stream may be in digital or analog form, and the broadcast may be any form or media used to communicate the video stream, including point to point communications. For clarity and ease of understanding, the example video search system presented herein will be presented in the context of a search system for news stories conforming to a set of user preferences, although the extension of the principles presented herein to other video search applications will be evident to one of ordinary skill in the art.

The example classification system 100 of FIG. 1 includes a story segment identifier 110, a classifier 120, and a visual characterizer 130. The story segment identifier 110 processes a video stream 101 and identifies discrete segments 111 of the video stream 101. In the example context, the video stream 101 corresponds to a news broadcast, and includes multiple news stories with interspersed advertisements, or commercials. The story segment identifier 110 partitions the video stream 101 into news story segments 111, either by copying each discrete story segment 111 from the video stream 101 to a storage device 115, or by forming a set of location parameters that identify the beginning and end of each discrete story segment 111 on a copy of the video stream 101. As illustrated by the dotted line 106, in a preferred embodiment, the video stream 101 is stored on a storage device 115 that allows for the replay of segments 111 based on the location of the segments 111 on the medium, such as a video tape recorder, laser disc, DVD, DVR, CD-R/W, computer file system, and the like. For ease of understanding, the invention is presented as having the story segments 111 stored on the storage device 115. As would be evident to one of ordinary skill in the art, this is equivalent to recording the entire video stream 101 and indexing each story segment 111 relative to the video stream 101.

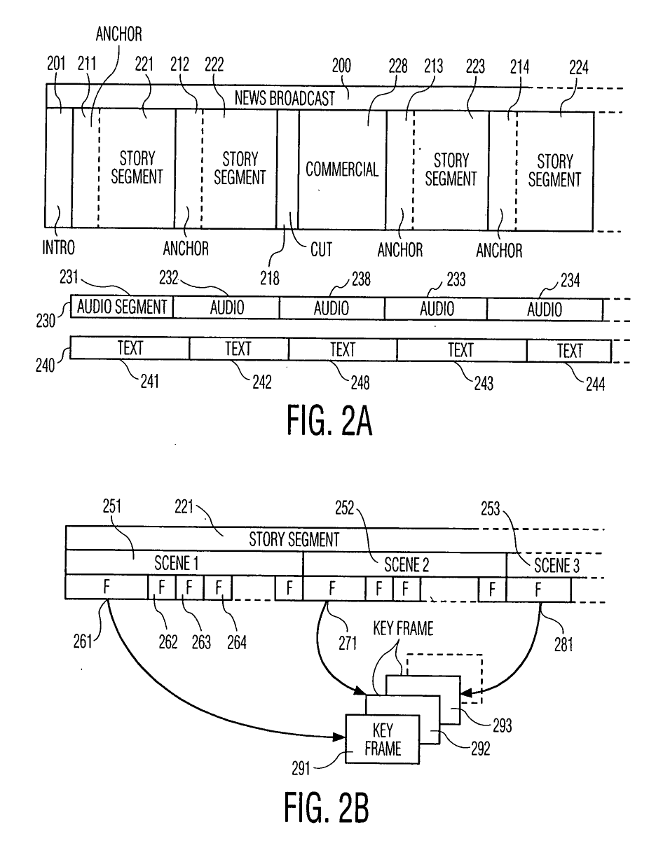

The story segments 111 are identified using a variety of techniques. The typical news broadcast follows a common format that is particularly well suited for story segmentation. FIG. 2A illustrates an example video stream 200 of a news broadcast. After an introduction 201, a newsperson, or anchor, appears 211 and introduces the first news story segment 221. After the first news story segment 221 is complete, the anchor reappears 212 to introduce the next story segment 222. After the story segment 222 is complete, there is a cut 218 to a commercial 228. After the commercial 228, the anchor reappears 213 and introduces the next story segment 223. This sequence of anchor-story, interspersed with commercials, repeats until the end of the news broadcast.

The repeated appearances 211-214 of the anchor, typically in the same staged location serves to clearly identify the start of each news segment and the end of the prior news segment or commercial. Techniques are commonly available to identify commercials in a video stream, as used for example in devices that mute the sound when a commercial appears. Commercials 228 may also occur within a story segment 222. The cut 218 to a commercial 228 may also include a repeated appearance of the anchor, but the occurrence of the commercial 228 serves to identify the appearance as a cut 218, rather than an introduction to a new story segment. The anchor may appear within the broadcast of the story segments 221-224, but most broadcasters use one staged location for story introductions, and different staged appearances for dialog shots or repeated appearances after a commercial. For example, the anchor is shown sitting at the news desk for a story introduction, then subsequent images of the newscaster are close ups, without the news desk in the image. Or, the anchor is presented full screen to introduce the story, then on a split screen when speaking with a field reporter. Or, the anchor shot is full facial to introduce a story, and profiled within the story. Once the characteristic story-introduction image is identified, image matching techniques common in the art can be used to automate the story segmentation process. In situations that do not have story segmentation breaks that lend themselves to automated story segmentation, manual or semi-automated techniques may be used as well. Also, as standards such as MPEG are developed for customizable video composition and splicing, it can be expected that video streams will contain explicit markers that identify the start and end of independent segments within the streams.

Also associated with the video stream is an audio stream 230 and, in many cases, a closed caption text stream 240 corresponding to the audio stream 230. Each story segment 221-224 of FIG. 2A has an associated audio segment 231-234, and possibly closed caption text 241-244. The audio segments 231-234 are synchronous with the video segments, and may be included within each story segment 221-224. Due to the differing transmission times of audio and text, the closed caption text segments 241-244 do not necessarily consume the same time span as the audio segments 231-234. The story segment identifier 110 may also include a speech recognition device that creates text segments 241-244 corresponding to each audio segment 231-234.

In addition to the transcripts of the audio segments, the text segments 241-244 include text from other sources as well. For example, in a non-news broadcast, a television guide may be available that provides a synopsis of each story, a list of characters, a reviewer's rating, and the like. In a news broadcast, an on-line guide may be available that provides a list of headlines, a list of newscasters, a list of companies or people contained in the broadcast, and the like. Also associated with each broadcast and each story segment are textual annotations indicating the broadcast channel being monitored by the broadcast channel selector 105, such as “ABC”, “NBC”, “CNN”, etc., as well as the name of each anchor introducing each story. The anchor's name may be automatically determined based on image recognition techniques, or manually determined. Other annotations may include the time of the broadcast, the locale of each story, and so on. In a preferred embodiment of this invention, each of these text formatted information segments will be associated with their corresponding story segment. Teletext formatted data may also be included in text segment 241-244.

The story segments 221-224, audio segments 231-234, and text segments 241-244 of FIG. 2A correspond to the story segments 111, audio segments 112, and text segments 113 from the story segment identifier 110 of FIG. 1, and the video 228, audio 238 and text 248 segments correspond to a commercial.

FIG. 2B illustrates the extraction of key frames from a story segment of a video stream in accordance with one aspect of this invention. The story segment 221 includes a number of scenes 251-253. For example, the first scene 251 of story segment 221 corresponds to the image 211 of the anchor introducing the story segment 221. The next scene 252 may be images from a remote camera covering the story, and so on. Each scene consists of frames. The first frame 261, 271, 281 of each scene 251, 252, 253 forms a set of key frames 291, 292, 293 associated with the story segment 221, the key frames forming a pictorial summary of the story segment 221. The key frames 291, 292, 293 of FIG. 2B correspond to the key frames 114 from the story segment identifier 110 of FIG. 1.

The first frame of each scene can be identified based upon the differences between frames. As the anchor moves during the introduction of the story, for example, only slight differences will be noted from frame to frame. The region of the image corresponding to the news desk, or the news room backdrop, will not change substantially from frame to frame. When a scene change occurs, for example by switching to a remote camera, the entire image changes substantially. A number of image compression or transform schemes provide for the ability to store or transmit a sequence of images as a sequence of difference frames. If the differences are substantial, the new frames are typically encoded directly as reference frames; subsequent frames are encoded as differences from these reference frames. FIG. 2B illustrates such a scheme by the relative size of each frame F in each scene 251-253. The first frame 261, 271, 281 of each scene 251, 252, 253 are encoded as reference frames, containing a substantial amount of information, or encoded as difference frames containing a substantial number of differences from their prior frames. After the change of scenes, subsequent frames are smaller, reflecting the same overall scene with minor changes caused by the movement of the objects in the frame or changes to the camera angle or magnification. The amount of information contained in each frame is directly related to the changes from one frame to the next. In the MPEG compression scheme, for example, images are transformed using a Discrete Cosine Transformation (DCT), which produces an encoding of each frame having a size that is strongly correlated to the amount of random change from one frame to the next. That is, for example, frames 262, 263, and 264 are shown to be substantially smaller than frame 261, because they contain less information than frame 261, which is the frame corresponding to a scene change. Thus, in a preferred embodiment of this invention, the key frames 291, 292, 293 correspond to the frames containing the most information 261, 271, 281 in the story segment 221. Other techniques of selecting key frames would be evident to one of ordinary skill in the art. For example, one could choose the frame from the center of each scene, or choose the frame having the least difference from all the other frames in the scene, using for example a least squares determination, and the like. As in the case of story segmentation, manual and semi-automated techniques may also be employed to select key frames, the composite of which form a pictorial summary of each story segment. Also as in the case of story segmentation, future encoding standards may include a direct indication of such key frames in each story segment.

The classifier 120 characterizes each story segment 111 of FIG. 1. In a preferred embodiment, the classifier 120 effects the characterization automatically, although manual or semi-automated techniques may be used as well. The primary means of characterization in the preferred embodiment is based on the text segments 113 from the story segment identifier 110. If the text segments 113 include annotations such as the broadcast channel and the anchor's name, these annotations are used to identify the story segment in corresponding “broadcaster” and “anchor” categories. If the text segments 113 are transcriptions or summaries of the story segment, keywords such as “victim”, “police”, “crime”, “defendant”, and the like are used to characterize a news story under the topic of “crime”. Keywords such as “democrat”, “republican”, “house”, “senate”, “prime minister”, and the like are used to characterize a news story under the topic of “politics”. Sub categorizations can also be defined, such that “home run” characterizes a story as sub category “baseball” under category “sports”, while “touch down” characterizes a story as sub category “football” under the same category “sports”. Similarly, particular names, such as “Clinton”, “Bill Gates”, “John Wayne” are used to categorize stories as “politics”, “computers”, “entertainment”, respectively. A story segment may have multiple categorizations; for example, “Bill Gates” may be used to categorize stories as both “computers” and “finance”. Similarly, the presence of “defendant” and “democrat” in the same story causes the story to be categorized as both “crime” and “politics”. In like manner, the audio segments 112 may be used for categorization. In an indirect manner, the audio segments 112 may be converted to text and the categorization applied to the text. In a direct manner, the audio segments 112 may be analyzed for sounds of laughter, explosions, gunshots, cheers, and the like to determine appropriate characterizations, such as “comedy”, “violence”, and “celebration”.

Optionally, a visual characterizer 130 characterizes story segments 111 based on their visual content. The visual characterizer 130 may be used to identify people appearing in the story segments, based on visual recognition techniques, or to identify topics based on an analysis of the image background information. For example, the visual characterizer 130 may include a library of images of noteworthy people. The visual characterizer 130 identifies images containing a single or predominant figure, and these images are compared to the images in the library. The visual characterizer 130 may also contain a library of context scenes and associated topic categories. For example, an image containing a person aside a map with isobars would characteristically identify the topic as “weather”. Similarly, image processing techniques can be used to characterize an image as an “indoor” or “outdoor” image, a “city”, “country”, or “sea” locale, and so on. These visual characterizations 131 are provided to the classifier 120 for adding, modifying, or supplementing the categorizations formed from the text 113 and audio 112 segments associated with each story segment 111. For example, the appearance of smoke in a story segment 111 may be used to refine a characterization of a siren sound in the audio segment 112 as “fire”, rather than “police”.

The visual characterizer 130 may also be used to prioritize key frames. A newscast may have dozens or hundreds of key frames based upon a selection of each new scene. In a preferred embodiment, the number of key frames is reduced by selecting those images likely to contain more information than others. Certain image contents are indicative of images having significant content. For example, a person's name is often displayed below the image of the person when the person is first introduced during a newscast. This composite image of a person and text will, in general, convey significant information regarding the story segment 111. Similarly a close-up of a person or small group of people will generally be more informative than a distant scene, or a scene of a large group of people. A number of image analysis techniques are commonly available for recognizing figures, flesh tones, text, and other distinguishing features in an image. In a preferred embodiment, key frames are prioritized by such image content analysis, as well as by other cues, such as the chronology of scenes. In general, the more important scenes are displayed earlier in the story segment 111 than less important scenes. The prioritization of key frames is also used to create a visual table of contents for the story segments 111, as well as for a visual table of contents for the video stream 101, by selecting a given number frames in priority order.

The classification system 100 provides the set of characterizations, or classification 121, of each story segment 111 from the classifier 120, and the set of key frames 114 for each story segment 111 from the story segment identifier 110, to the retrieval system 150. The classification 121 may be provided in a variety of forms. Predefined categories such as “broadcaster”, “anchor”, “time”, “locale”, and “topic” are provided in the preferred embodiment, with certain categories, such as “locale” and “topic” allowing for multiple entries. Another method of classification that is used in conjunction with the predefined categories is a histogram of select keywords, or a list of people or organizations mentioned in the story segment 111. The classification 121 used in the classification system 100 should be consistent or compatible with, albeit not necessarily identical to, the filtering system used in the filter 160 of the retrieval system 150. As would be evident to one of ordinary skill in the art, a classification translator can be appended between the classification system 100 and retrieval system 150 to convert the classification 121, or a portion of the classification 121, to a form that is compatible with the filtering system used in the filter 160. This translation may be automatic, manual, or semi-automated. For ease of understanding, it is assumed herein that the classification 121 of each story segment 111 by the classification system 100 is compatible with the filter 160 of the retrieval system 150.

The filter 160 of the retrieval system 150 identifies the story segments 111 that conform to a set of user preferences 191, based on the classification 121 of each of the story segments 111. In a preferred embodiment of this invention, the user is provided a profiler 190 that encodes a set of user input into preferences 191 that are compatible with the filtering system of the filter 160 and compatible with the classification 121. For example, if the classification 121 includes an identification of broadcast channels or anchors, the profiler 190 will provide the user the option of specifying particular channels or anchors for inclusion or exclusion by the filter 160. In a preferred embodiment, the profiler 190 includes both “constant” as well as “temporal” preferences, allowing the user to easily modify those preferences that are dependent upon the user's current state of mind while maintaining a set of overall preferences. In the temporal set, for example, would be a choice of topics such as “sports” and “weather”. In the constant set, for example, would be a list of anchors to exclude regardless of whether the anchor was addressing the current topic of interest. Similarly, the constant set may include topics such as “baseball” or “stock market”, which are to be included regardless of the temporal selections. Consistent with common techniques used for searching, the profiler 190 allows for combinations of criteria using conjunctions, disjunctions, and the like. For example, the user may specify a constant interest in all “stock market” stories that contain one or more words that match a specified list of company names.

The filter 160 identifies each of the story segments 111 with a classification 121 that matches the user preferences 191. The degree of matching, or tightness of the filter, is controllable by the user. In the extreme, a user may request all story segments 111 that match any one of the user's preferences 191; in another extreme, the user may request all story segments 111 that match all of the user's preferences 191. The user may request all story segments 111 that match at least two out of three topic areas, and also contain at least one of a set of keywords, and so on. The user may also have negative preferences 191, such as those topics or keywords that the user does not want, for example “sports” but not “hockey”. The filter 160 identifies each of the story segments 111 satisfying the user's preferences 191 as filtered segments 161. In a preferred embodiment, the filter 160 contains a sorter that ranks each story in dependence upon the degree of matching between the classification 121 and the user preferences 191, using for example a count of the number of keywords of each topic in each classification 121 of the story segments 111. For ease of understanding, the ranking herein is presented as a unidimensional, scalar quantity, although techniques for multidimensional ranking, or vector ranking, are common in the art. In the case of the same story being reported on multiple broadcast channels, the ranking 162 may be heavily weighted by the user's preferred anchor, or preferred broadcast channel; this ranking 162 may also be weighted by the time of each newscast, in preference to the most recent story. In a preferred embodiment, the user has the option to adjust the weighting factors. For example, the user may make a negative selection absolute: if the segment contains the negated topic or keyword, it is assigned the lowest rating, regardless of other matching preferences. Any number of common techniques can be used to effect such prioritization, including the use of artificial intelligence techniques such as knowledge based systems, fuzzy logic systems, expert systems, learning systems and the like. The filter 160 selects story segments 111 based on this ranking 162, and provides the ranking 162 of each of these selected, or filtered, segments 161 to the presenter 170 of the retrieval system 150.

In another embodiment of this invention, the filter 160 also identifies the occurrences of similar stories in multiple story segments, to identify popular stories, commonly called “top stories”. This identification is determined by a similarity of classifications 121 among story segments 111, independent of the user's preferences 191. The similarity measure may be based upon the same topic classifications being applied to different story segments 111, upon the degree of correlation between the histograms of keywords, and so on. Based upon the number of occurrences of similar stories, the filter 160 identifies the most popular current stories among the story segments 111, independent of the user's preferences 191. Alternatively, the filter 160 identifies the most popular current stories having at least some commonality with the preferences 191. From these most popular current stories, the filter chooses one or more story segments 111 for presentation by the presenter 170, based upon the user's preferences 191 for broadcast channel, anchor person, and so on.

In accordance with this invention, the presenter 170 presents the key frames 114 of the filtered story segments 161 on a display 175. As discussed above, the set of key frames associated with each story segment 111 provides a pictorial summary of each story segment 111. Thus, in accordance with this invention, the presenter 170 presents the pictorial summary 171 of those story segments 161 which correspond to the user preferences 191. In a preferred embodiment, the number of key frames displayed for each story segment 161 is determined by the aforementioned prioritization schemes based on image content, chronology, associated text, and the like. Optionally, the presentation of the pictorial summary may be accompanied by the playing of portions of the audio segments that are associated with the story segment 111. For example, the portion of the audio segment may be the first audio segment of each story segment, corresponding to the introduction of the story segment by the anchor. In like manner, a summary of the text segment may also be displayed coincident with the display of the pictorial summary 171. When a particular filtered story segment's pictorial summary 171 strikes the user's interest, the user selects the filtered story segment for full playback by a player 180 in the retrieval system 150. Common in the art, the user may effect the selection by pointing to the displayed key frames of the story of interest, using for example a mouse, or by voice command, gesture, keyboard input, and the like. Upon receipt of the user selection 176 the player 180 displays the selected story segment 181 on the display 175.

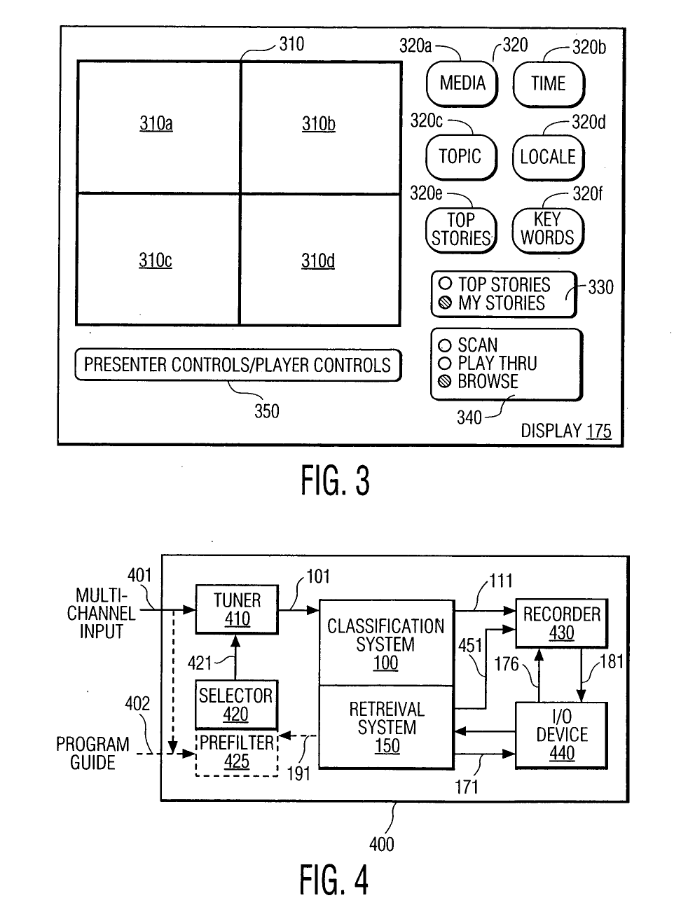

FIG. 3 illustrates an example user interface for the retrieval system 150. The display 175 contains panes 310 for displaying filtered story segments key frames 171. As illustrated in FIG. 3, the display 175 includes four panes 310a, 310b, 310c and 310d, although fewer or more panes can be selected via the presenter controls 350. The presenter sequentially presents each of the key frames 171 in the panes 310. In a preferred embodiment, each of the key frames 171 corresponding to one story segment 161 are presented sequentially in one of the panes 310a, 310b, 310c, or 310d. That is, in FIG. 3 the key frames of four story segments 161 are displayed simultaneously, each pane providing the pictorial summary for each of the story segments 161. The user has the option of determining the duration of each key frame 171, and whether the key frames 171 from a story segment 161 are repeated for a given time duration before the set of key frames 171 from another story segment 161 are presented in that pane. After all the key frames 114 of all the filtered story segments 161 are presented, the cycle is repeated, thereby providing a continuous slide show of the key frames of story segments that conform to the user's preferences. Alternative display methods can be employed. For example, four segments from a story segment 161 may be displayed in all four of the panes 310a-310d simultaneously. Similarly, one pane may be defined as a primary pane, which is configured to contain the highest priority scene of the story segment 161 while the other panes sequentially display lower priority scenes. These and other techniques for video presentation will be apparent to one of ordinary skill in the art. In a preferred embodiment, presenter controls 350 are provided to facilitate the customization of the presentation and selection of key frames 171.

If the filter 160 provides a ranking 162 associated with each filtered story segment 161, the presenter 170 can use the ranking 162 to determine the frequency or duration of each presented set of key frames 171. That is, for example, the presenter 170 may present the key frames 114 of filtered segments 161 at a repetition rate that is proportional to the degree of correspondence between the filtered segments 161 and user preferences 191. Similarly, if a large number of filtered segments 161 are provided by the filter 160, the presenter 170 may present the key frames 114 of the segments 161 that have a high correspondence with the user preferences 191 at every cycle, but may present the key frames 114 of the segments that have a low correspondence with the user preferences 191 at fewer than every cycle.

The presenter controls 350 also allow the user to control the interaction between the presenter 170 and the player 180. In a preferred embodiment, the user can simultaneously view a selected story segment 181 in one pane 310 while key frames 171 from other story segments continue to be displayed in the other panes. Alternatively, the selected story segment 181 may be displayed on the entire area of the display 175. These and other options for visual display are common to one of ordinary skill in the art. The user is also provided play control functions in 350 for conventional playback functions such as volume control, repeat, fast forward, reverse, and the like. Because the story segments 111 are partitioned into scenes in the story segment identifier, the playback functions 350 may include such options as next scene, prior scene, and so on.

The user interface to the profiler 190 is also provided via the display 175. In the example interface of FIG. 3, buttons 320 are provided to allow the user to set preferences 191 in select categories. The “media” button 320a provides the user options regarding the broadcast channels, anchor persons, and the like. The “time” button 320b provides the user options regarding time settings, such as how far back in time the filter 160 should consider story segments. The “topics” button 320c allows the user to choose among topics, such as sports, art, finance, crime, etc. The “locale” button 320d allows the user to specify geographic areas of interest. The “top stories” button 320e allows the user to specify filter parameters that are to applied to the aforementioned identification of popular story segments. The “keywords” button 320f allows the user to identify specific keywords of interest. Other categories and options may also be provided, as would be evident to one of ordinary skill in the art.

The user interface of FIG. 3 also allows for selection of presentation 330 and player 340 modes. The presentor 170 can be set to present key frames of story segments selected by the user's preference settings, or key frames of “top” story segments. The player 180 can be set to operate in a browse mode, corresponding to the operation discussed above, wherein the user browses the key frames and selects story segments of interest; or in a play thru mode, wherein the player 180 presents each of the filtered story segments 161 in succession; and in a scan mode, wherein the player 180 presents the first scene of each filtered story segment 161 in succession.

Other means of presenting key frames and associated materials can be provided. The presentation can be multidimensional, wherein, for example, the degree of correlation of a segment 111 to the user's preferences 191 identifies a depth, and the key frames are presented in a multidimensional perspective view using this depth to determine how far away from the user the key frames appear. Similarly, different categories 320 of user preferences can be associated with different planes of view, and the key frames of each segment having strong correlation with the user preferences in each category are displayed in each corresponding plane. These and other presentation techniques will be evident to one of ordinary skill in the art, in view of this invention.

Although the invention has been presented primarily in the context of a news retrieval system, the principles presented herein will be recognized by one of ordinary skill in the art to be applicable to other retrieval tasks as well. For example, the principles of the invention presented herein can be used for directed channel-surfing. Traditionally, a channel-surfing user searches for a program of interest by randomly or systematically sampling a number of broadcast channels until one of the broadcast programs strikes the user's interest. By using the classification system 100 and retrieval system 150 in an on-line mode, a more efficient search for programs of interest can be effected, albeit with some processing delay. In an on-line mode, the story segment identifier 110 provides text segments 113, audio segments 112, and key frames 114 corresponding to the current non-commercial portions of the broadcast channel. The classifier 120 classifies these portions using the techniques presented above. The filter 160 identifies those portions that conform to the user's preferences 191, and the presenter 170 presents the set of key frames 171 from each of the filtered portions 161. When the user selects a particular set of key frames 171, the broadcast channel selector 105 is tuned to the channel corresponding to the selected key frames 171, and the story segment identifier 110, storage device 115 and player 180 are placed in a bypass mode to present the video stream 101 of the selected channel to the display 175.

As would be evident to one of ordinary skill in the art, the principles and techniques presented in this invention can include a variety of embodiments. FIG. 4 illustrates an example consumer product 400 in accordance with this invention. The product 400 may be a home computer or a television; it may be a video recording device such as a VCR, CD-R/W, or DVR device; and so on. The example product 400 records potentially interesting story segments 111 for presentation and selection by a user. The story segments 111 are extracted or indexed from a video stream 101 by the classification system 100, as discussed above with regard to FIG. 1. The video stream 101 is selected from a multichannel input 401, such as a cable or antenna input, via a selector 420 and tuner 410.

In one embodiment of FIG. 4, the selector 420 is a programmable multi-event channel selector, such as found in conventional VCR devices. The user programs the selector 420 to tune the tuner 410 to a particular channel of interest at each particular event time for a specified duration. For example, a user may program the time and duration of morning news on one channel, the evening news on another channel, and late night news on yet another channel. As each channel is subsequently selected by the selector 420, the stories 111 are segmented and stored on the recorder 430 via the classification system 100, which also classifies each segment 111 and extracts relevant key frames 171 for display on the input/output device 440, as discussed above. In a preferred embodiment, the recorder 430 is a continuous-loop recorder, or continuous circular buffer recorder, which automatically erases the oldest segments 111 as it records each of the newest segments 111, so as to continually provide as many recent segments 111 as it recording media allows. The user accesses the system via the input/output device 440 and is presented the key frames of the most recent segments 111 that match the user's preferences; thereafter, the user selects segments 181 for display based on the presented key frames 171.

A number of optional capabilities are also illustrated in FIG. 4. To optimize the use of the available recording media, the retrieval system 150 may be configured to provide selective erasure, via 451, rather than the oldest-erasure scheme discussed above. When a new segment 111 requires an allocation of the recording media, the retrieval system 150 identifies the segments 111 that are on the recording media that have the least correlation with the user's preferences. Instead of replacing the oldest segments with the newest segments, the segments of least potential interest to the user are replaced by the newest segments. The retrieval system 150 also terminates the recording of the newest segment when it determines, based on the classification of the newest segment by the classification system 100, that the newest segment is of no interest to the user, based on the user preferences.

Also illustrated by dashed lines 191 and 402, the product 400 optionally provides for the selection of channels by the selector 420 via a prefilter 425. The prefilter 425 effects a filtering of the segments 111 by controlling the selection of channels 401 via the selector 420 and tuner 410. As noted above, ancillary text information is commonly available that describes the programs that are to be presented on each of the channels of the multichannel input 401. As illustrated by the dashed lines, this ancillary information, or program guide, may be a part of the multichannel input 401, or via a separate program guide connection 402. Using techniques similar to those of filter 160, discussed above, the prefilter 425 identifies the programs in the program guide 402 that have a strong correlation with the user preferences 191, and programs the selector 420 to select these programs for recording, classification, and retrieval, as discussed above.

As would be evident to one of ordinary skill in the art, the capabilities and parameters of this invention may be adjusted depending upon the capabilities of each particular embodiment. For example, the product 400 may be a portable palm-top viewing device for commuters who have little time to watch live newscasts. The commuter connects the product 400 to a source of multichannel input 401 overnight to record stories 111 of potential interest; then, while commuting (as a passenger) uses the product 400 to retrieve stories of interest 181 from these recorded stories 111. In this embodiment, resources are limited, and the parameters of each component are adjusted accordingly. For example, the number of key frames 114 associated with each segment 111 may be substantially reduced, the prefilter 425 or filter 160 may be substantially more selective, and so on. Similarly, the classification 100 and retrieval systems 150 of FIG. 1 may be provided as standalone devices that dynamically adjusts their parameters based upon the components to which they are attached. For example, the classification system 100 may be a very large and versatile system that is used for classifying story segments for a variety of users, and different models of retrieval systems 150, each having different levels of complexity and cost, are provided to the users for retrieving selected story segments.

The foregoing merely illustrates the principles of the invention. It will thus be appreciated that those skilled in the art will be able to devise various arrangements which, although not explicitly described or shown herein, embody the principles of the invention and are thus within its spirit and scope. For example, the key frames 114 have been presented herein as singular images, although a key frame could equivalently be a sequence of images, such as a short video clip, and the presentation of the key frames would be a presentation of each of these video clips. The components of the classification system 100 and retrieval system 150 may be implemented in hardware, software, or a combination of both. The components may include tools and techniques common to the art of classification and retrieval, including expert systems, knowledge based systems, and the like. Fuzzy logic, neural nets, multivariate regression analysis, non-monotonic reasoning, semantic processing, and other tools and techniques common in the art can be used to implement the functions and components presented in this invention. The presentor 170 and filter 160 may include a randomization factor, that augments the presentation of key frames 114 of segments 161 having a high correspondence with the user preferences 191 with key frames 114 of randomly selected segments, regardless of their correspondence with the preferences 191. The source of the video stream 101 may be digital or analog, and the story segments 111 may be stored in digital or analog form, independent of the source of the video stream 101. Although the invention has been presented in the context of television broadcasts, the techniques presented herein may also be used for the classification, retrieval, and presentation of video information from sources such as public and private networks, including the Internet and the World Wide Web, as well. For example, the association between sets of key frames 114 and story segments 111 may be via embedded HTML commands containing web site addresses, and the retrieval of a selected story segment 181 is via the selection of a corresponding web site.

As would be evident to one of ordinary skill in the art, the partition of functions presented herein are presented for illustration purposes only. For example, the broadcast channel selector 105 may be an integral part of the story segment identifier 110, or it may be absent if the classification and retrieval system is being used to retrieve story segments from a single source video stream, or a previously recorded video stream 101. Similarly, the story segment identifier 110 may process multiple broadcast channels simultaneously using parallel processors. The filter 160 and profiler 190 may be integrated as a single selector device. The key frames 114 may be stored on, or indexed from, the recorder 115, and the presenter 170 functionality provided by the player 180. In like manner, the extraction of key frames 114 from the story segments 111 may be effected in either the story segment identifier 110 or in the presenter 170. These and other partitioning and optimization techniques will be evident to one of ordinary skill in the art, and within the spirit and scope of this invention.

1-16. (Cancelled).

17. A retrieval system for retrieving story segments of a plurality of story segments based on one or more classifications associated with each story segment of the plurality of story segments, the retrieval system comprising:
a filter for identifying one or more filtered story segments of the plurality of story segments based on the one or more classifications that are associated with each story segment; and
a presenter, operably coupled to the filter, for sequentially presenting one or more key frames associated with the one or more filtered story segments on a display.

18. The retrieval system as claimed in claim 17, wherein:
the filter includes a sorter for associating a ranking to each story segment based on a correlation of the one or more classifications to one or more preferences; and
the one or more filtered story segments are identified based on the ranking associated with each story segment.

19. The retrieval system as claimed in claim 18, wherein:
the presenter presents the one or more key frames in dependence upon the ranking associated with each story segment.

20. The retrieval system as claimed in claim 18, wherein said retrieval system further includes:
a profiler for producing the one or more preferences.

21. The retrieval system as claimed in claim 17, wherein the one or more classifications include at least one of: program type, news type, media, person, locale, popularity, and keyword.

22. The retrieval system as claimed in claim 17, wherein said retrieval system further includes:
a player, operably coupled to the presenter, for presenting a selected story segment of the one or more filtered story segments based upon the one or more key frames that are presented on the display at a time when a user effects a selection.

23. The retrieval system as claimed in claim 22, wherein the player also presents a portion of each of the one or more filtered story segments sequentially.

24. The retrieval system as claimed in claim 17, wherein said retrieval system further includes:
a storage device for storing the plurality of story segments.

25. The retrieval system as claimed in claim 24, wherein the storage device is at least one of: a VCR, a DVR, a CD-R/W, and a computer memory.

26. The retrieval system as claimed in claim 17, wherein:
the presenter also presents at least one of: one or more portions of an audio segment and one or more portions of a text segment that are associated with the one or more filtered story segments.

27. A video device comprising:
a classification device for classifying a plurality of segments of a video stream by producing a classification based on at least one of text, audio, or visual information associated with each segment of the plurality of segments; and
a retrieval device for facilitating a selection of an at least one segment of the plurality of segments by matching the classification of the at least one segment of the plurality of segments to at least one user preference, and by presenting at least one key frame of the at least one segment of the plurality of segments on a display.

28. The video device as claimed in claim 27, wherein said video device further includes:
a player for communicating the at least one segment of the video stream to the display-based on the selection of the at least one segment.

29. The video device as claimed in claim 27, wherein said video device further includes:
a storage device for storing the plurality of segments.

30. The video device as claimed in claim 27, wherein the video device is at least one of: a television, a set-top box, a video recorder, a computer, and a palm-top device.

31. The video device as claimed in claim 27, wherein the video device further includes:
a pre-filter for filtering a multi-channel input to provide the video stream based on the at least one user preference.

32. The video device as claimed in claim 31, wherein the pre-filter filters the multi-channel input based on a program guide.

33. A user interface for retrieving a selected segment of a plurality of segments of a video stream, said user interface comprising:
means for rendering one or more key frames associated with one or more segments of the plurality of segments; and
means for selecting the selected segment based on the rendering of the one or more key frames.

34. The user interface claimed in claim 33, wherein said user interface further comprises:
the means for identifying one or more user preferences; and wherein:
the means for rendering the one or more key frames includes:
means for determining a comparison between a classification of each segment of the plurality of segments and the one or more user preferences; and wherein
the rendering of the one or more key frames is dependent upon the comparison.

35. The user interface as claimed in claim 34, wherein:
the means for rendering the one or more key frames includes one or more panes on the display; and
the one or more key frames associated with each of the one or more segments are displayed sequentially in the one or more panes.

36. The user interface as claimed in claim 35, wherein:
the means for selecting the selected segment includes a means for indicating a selection of a selected pane of the one or more panes, whereby the selected segment corresponds to a one of the one or more segments that is associated with the one or more key frames being displayed in the selected pane.

37. The user interface as claimed in claim 33, wherein said user interface further comprises:
a means for rendering the selected segment on the display.

38. The user interface as claimed in claim 37, wherein said user interface further comprises:
a rendering control for receiving render mode options; and
means for rendering portions of each segment of the plurality of segments in dependence upon the render mode options.

39. The user interface claimed in claim 33, wherein the means for selecting the selected segment includes at least one of: a pointing device, a voice recognition system, a gesture recognition system, and a keyboard.

40. The user interface as claimed in claim 33, wherein the means for rendering the one or more key frames of the plurality of segments includes a multi-dimensional presentation of at least one of: the one or more key frames, one or more user preferences, and one or more user options.
